(19) United States
(12) Patent Application Publication
(10) Pub. No.: US 2016/0050950 A1
(43) Pub. Date: Feb. 25, 2016

(54) CREAMER COMPOSITION COMPRISING PLANT PROTEIN MICROPARTICLES

(71) Applicant: NESTEC S.A., Vevey (CH)

(72) Inventors: Christophe Joseph Etienne SCHMITT, Servion (CH); Koraljka RADE-KUKIC, Savigny (CH)

(21) Appl. No.: 14/780,400

(22) PCT Filed: Apr. 29, 2014
(86) PCT No.: PCT/EP2014/058736

§ 371 Date: Sep. 25, 2015

(30) Foreign Application Priority Data
Apr. 30, 2013 (EP) 13166079.7

(51) Int. Cl. A23C 11/10; A23C 11/08

(52) U.S. Cl. CPC A23C 11/10; A23C 11/08

(57) ABSTRACT

The present invention relates to use of plant protein microparticles as whitening agents in creamer compositions. The invention also relates to a method of producing a creamer composition, and a method of preparing a beverages composition.

### FIELD OF THE INVENTION

The present invention relates to creamers that may be used e.g. for adding to coffee, tea, and cocoa beverages, and to methods of producing creamers.

### BACKGROUND

Creamers are widely used as whitening agents with hot and cold beverages such as, for example, coffee, cocoa, tea, etc. They are commonly used in place of milk and/or dairy cream. Creamers may come in a variety of different flavors and provide mouthfeel, body, and a smoother texture. Creamers can be in liquid or powder forms. A liquid creamer may be intended for storage at ambient temperatures or under refrigeration, and should be stable during storage without phase separation, creaming, gelation and sedimentation. The creamer should also retain a constant viscosity over time. When added to cold or hot beverages such a coffee or tea, the creamer should disperse rapidly, provide a good whitening capacity, and remain stable with no feathering and/or sedimentation while providing a superior taste and mouthfeel.

Emulsions and suspensions are not thermodynamically stable, and there is a real challenge to overcome physico-chemical instability issues in the liquid creamers that contain oil and other insoluble materials, especially for the aseptic liquid creamers during long storage times at ambient or elevated temperatures. Moreover, over time, creaming that can still be invisible in the liquid beverages stored at room and elevated temperatures can cause a plug in the bottle when refrigerated.

Conventionally, low molecular emulsifiers, such as e.g. mono- and diglycerides, are added to non-dairy liquid creamers to ensure stability of the oil-in-water emulsion. Low molecular weight emulsifiers are effective stabilisers of the oil-in-water emulsion.

In addition to the low molecular emulsifiers some non-dairy liquid creamers are made using addition of whitening agent/color (e.g. titanium dioxide) which is used in the creamer to provide a required whitening capacity when added to beverages (coffee, tea, and like). This is particular the case for fat free or low fat non-dairy liquid creamers. Due to it mineral nature and high density (about 4.2 g·cm⁻³), titanium dioxide can be very abrasive and may lead to some premature damages in factory pipes. Its high density also requires the use of combinations of hydrocolloids in order to prevent sedimentation over product shelf-life which may lead to recipe complexity. To overcome these technical problems, there is a need for alternative ingredients, to provide stable product with required whitening capacity.

FR 2942586 discloses the use of a 30% emulsion based plant protein and hydrolyzed starch as coffee creamer. The disclosure is not concerned with plant protein micro-particles and the solution provided does not work without fat.

WO2010065570 discloses protein that is hydrolyzed. Here again it is the emulsion which provides the whitening effect. It requires fat and does not allow making low fat or fat free non-dairy creamers.

WO2004071203 discloses a coffee creamer based on commercial microparticulated whey-proteins associated with oil/oil that is used to reproduce the fat mouthfeel of a full fat dairy creamer. WO2004030464 provides also a disclosure of a beverage wherein the fat mouthfeel improving agent. None of these disclosures provide a solution to the need of whitening the beverage.

It is also know in the prior art to add soy milk for whitening coffee. Traditional soy milk provides an aftertaste from soy is unacceptable for many consumers.

In view of the previous discussion, there are numerous challenges in creating a liquid creamer without low molecular emulsifiers, which is homogeneous, shelf-stable, and shows good physical stability.

### SUMMARY OF THE INVENTION

It has surprisingly been found that use of plant protein microparticles as whitening agents can provide an effective whitening power. The plant protein microparticles may replace some or all of the other whitening agents in the creamer including fat and coloring agents.

By plant protein microparticles, it is meant a particle that is obtained by heat-treatment and subsequent homogenisation of a dispersion of non-aggregated plant protein. The resulting microparticles preferably have a size distribution between 100 and 4000 nm and/or preferably have a stable optical density at 500 nm of at least 0.680 when measured after 10 minutes in 2.4% (w/w) soluble coffee.

Accordingly, the present invention relates to use of plant protein microparticles as whitening agents in a creamer composition. In a preferred embodiment of the invention the plant protein microparticles in the creamer composition have an irregular shape. In the present context irregular shape means non-spherical.

In further embodiments, the invention relates to a method of producing a creamer composition of the invention as well as a method of preparing a beverage composition.

It was surprisingly found that the plant protein microparticles provide a good whitening capacity of low fat liquid creamers when added to beverages such as coffee or tea. This allows avoiding the addition of artificial colors to the creamer such as TiO₂. Moreover, the extracted emulsion mixture is found to be stable in hot, acidic liquid, especially with high level of minerals when hard water is used to prepare coffee or tea. Furthermore, the plant protein particles do not negatively affect taste/mouthfeel of the liquid creamers as well of beverages with the creamers added.

### BRIEF DESCRIPTION OF THE FIGURES

FIG. 1 shows the intensity-based particle size distribution of plant protein micro-particles at 0.04% (w/w). (A): Potato; (B): Soy.

FIG. 2 shows Transmission electron micrographs in negative staining mode of plant protein micro-particles. (A): Soy; (B): Potato; (C): Canola. Scales bars are representing 500 nm on figure A and 1 μm on figures B and C.

FIG. 3 shows macroscopic stability of plant protein microparticles at various protein concentrations in 2.6% (w/w) soluble coffee at 1/6 weight mixing ratio. Pictures were taken after 10 minutes. (A): Soy; (B): Potato; (C): Canola. Corresponding lightness values of the mixture are indicated below the pictures.

FIG. 4 shows process flow for production of soy microparticle-based low fat creamers according to the invention.

FIG. 5 shows frequency-based particles size distributions of commercial coffee creamers and coffee creamers according to the invention based on soy protein microparticles.

FIG. 6 shows TEM micrograph in negative staining mode for a 2.4% (w/w) coffee creamer according to the invention containing 6% (w/w) soy protein microparticles. 0: Oil droplets; SPM: Soy protein microparticles. Scale bar is 200 nm.

FIG. 7 shows macroscopic stability of soy protein microparticle-based creamers in 0.67% (w/w) roast and ground coffee at 1/6 weight mixing ratio. Pictures were taken after 10 minutes. Corresponding lightness values of the mixtures are indicated below the pictures.

### DETAILED DESCRIPTION OF THE INVENTION

According to the present invention a creamer composition is provided which has a good physical stability. By physical stability is meant stability against phase separation, plug formation, flocculation and/or aggregation of fat due to fat crystallization and/or formation of an oil rich fraction in the upper part of the composition due to aggregation and/or coalescence of oil droplets, e.g. aggregation and/or coalescence of oil droplets to form a hard “plug” in the upper part of the product.

By a creamer composition is meant a composition that is intended to be added to a food composition, such as e.g. coffee or tea, to impart specific characteristics such as colour (e.g. whitening effect), thickening, flavour, texture, and/or other desired characteristics. A creamer composition of the invention is preferably in liquid form, but may also be in powdered form.

In the present context a full fat creamer comprises above 15% fat while a low fat creamer comprises below 15% lipids.

Further in the present context unless otherwise indicated % of a component means the % of weight based on the weight of the creamer composition, i.e. weight/weight (w/w) %.

By particle size distribution is meant the range of size that the microparticles can exhibit. The size can be measure with convention means e.g. equipment and method mentioned in Example 1. In a preferred embodiment of the invention the creamer composition comprises protein microparticles having a size distribution from 100 to 4000 nm.

In the present context by optical density of plant protein is meant the amount of light that is scattered by the sample when going through it. The optical density can be measure with convention means e.g. the equipment and method described in Example 1. In a preferred embodiment of the invention the creamer composition has an optical density measured at 500 nm of at least 0.680 when measured after 10 minutes in in 2.4% (w/w) soluble coffee. The stability of the optical density is a sign of stability of the particles against sedimentation.

The plant protein microparticles are preferably present in the creamer composition of the invention in an amount of between about 2% and about 12% (weight/weight), such as between about 3% and about 8%, more preferably between about 4% and about 7%. If too little plant protein microparticles are used the whitening effect is not achieved. At high levels of the plant protein microparticles very high whitening properties are obtained but could also lead to some processing issues (viscosity increase during or post-pasteurisation treatment).

In a preferred embodiment of the invention, the creamer composition comprises plant protein microparticles that are selected from the group consisting of soy protein, potato protein, canola protein, pea protein, corn protein, wheat protein, rice protein or combinations thereof. In a particular preferred embodiment of the invention, the plant protein microparticles are selected from the group consisting of soy protein, potato protein, and canola protein or a combination thereof. If soy protein is used alone it is preferable present in an amount from 4 to 8% (w/w). If potato protein is used alone it is preferably in present in an amount from 2 to 4% (w/w). If canola protein is used alone it is preferably present in an amount from 4 to 12% (w/w).

The creamer composition of the invention further comprises protein in addition to plant protein microparticles, preferably between about 0.1% (weight/weight) and about 3% protein, such as between about 0.2% (weight/weight) and about 2% protein, more preferably between about 0.5% (weight/weight) and about 1.5% protein. The protein may be any suitable protein, e.g. milk protein, such as casein, caseinate, and whey protein; vegetable protein, e.g. soy, potato, wheat, corn and/or pea protein; and/or combinations thereof. The protein is preferably sodium caseinate. The protein in the composition may work as an emulsifier, provide texture, and/or provide whitening effect. Too low levels of protein may reduce the stability of the liquid creamer and creaming may occur. At high protein levels phase separation may occur.

It has surprisingly been found that the creamer composition according to the invention shown to have good whitening properties in coffee and other beverages or food products. In a preferred embodiment of the invention the creamer composition has a lightness of at least 25 when added at a level of 0.67% (w/w) when measured after 10 minutes in 2.4% (w/w) soluble coffee.

A preferred creamer composition according to the invention comprised sucrose, emulsifiers, stabilizers, buffer salts, sweeteners and aroma. In addition the creamer composition may advantageously comprise emulsifiers that are protein not in the form of microparticles.

In one embodiment, the creamer composition of the invention comprises oil. The oil may be any oil, or combination oils, suitable for use in a liquid creamer. The oil is preferably a vegetable oil, such as e.g. oil from canola, soy bean, sunflower, safflower, cotton seed, palm oil, palm kernel oil, corn, and/or coconut. The oil is preferably present in an amount of at most about 20% (weight/weight), the amount of oil in the creamer composition may e.g. be between about 0% and about 20% (weight/weight). More preferably the creamer composition of the invention comprising between 0% and 10% oil or fat by weight (w/w), preferably from 0% to 5% oil or fat by weight (w/w).

The creamer composition of the present invention may further include a buffering agent. The buffering agent can prevent undesired creaming or precipitation of the creamer upon addition into a hot, acidic environment such as coffee. The buffering agent can e.g. be monophosphates, diphosphates, sodium mono- and bicarbonates, potassium mono- and bicarbonates, or a combination thereof. Preferred buffers are salts such as potassium phosphate, dipotassium phosphate, potassium hydrophosphate, sodium bicarbonate, sodium citrate, sodium phosphate, disodium phosphate, sodium hydrophosphate, and sodium tripolyphosphate. The buffer may e.g. be present in an amount of about 0.1 to about 1% by weight of the liquid creamer.

The creamer composition of the present invention may further include one or more additional ingredients such as flavors, sweeteners, colorants, antioxidants (e.g. lipid antioxidants), or a combination thereof Sweeteners can include, for example, sucrose, fructose, dextrose, maltose, dextrin, levulose, tagatose, galactose, corn syrup solids and other natural or artificial sweeteners. Sugarless sweeteners can include, but are not limited to, sugar alcohols such as maltitol, xylitol, sorbitol, erythritol, mannitol, isomalt, lactitol, hydrogenated starch hydrolysates, and the like, alone or in combination. Usage level of the flavors, sweeteners and colorants will vary greatly and will depend on such factors as potency of the sweetener, desired sweetness of the product, level and type of flavor used and cost considerations. Combinations of sugar and/or sugarless sweeteners may be used. In one embodiment, a sweetener is present in the creamer composition of the invention at a concentration ranging from about 5% to about 40% by weight. In another embodiment, the sweetener concentration ranges from about 25% to about 30% by weight.

The invention further relates to a method of producing a creamer composition of the invention. The method comprises providing a composition, the composition comprising water, plant protein microparticles, and optionally additional ingredients as disclosed herein; and homogenising the composition to produce a creamer composition. Before homogenisation, optional compounds such as, hydrocolloids, buffers, sweeteners and/or flavors may be hydrated in water (e.g., at between 40° C. and 90° C.) under agitation, with addition of melted oil if desired. The method may further comprise heat treating the composition before homogenisation, e.g. by aseptic heat treatment. Aseptic heat treatment may e.g. use direct or indirect UHT processes. UHT processes are known in the art. Examples of UHT processes include UHT sterilization and UHT pasteurization. Direct heat treatment can be performed by injecting steam into the emulsion. In this case, it may be necessary to remove excess water, for example, by flashing. Indirect heat treatment can be performed with a heat transfer interface in contact with the emulsion. The homogenization may be performed before and/or after heat treatment. It may be advantageous to perform homogenization before heat treatment if oil is present in the composition, in order to improve heat transfers in the emulsion, and thus achieve an improved heat treatment. Performing a homogenization after heat treatment usually ensures that the oil droplets in the emulsion have the desired dimension. After heat treatment the product may be filled into any suitable packaging, e.g. by aseptic filling. Aseptic filling is described in various publications, such as articles by L, Grimm in “Beverage Aseptic Cold Filling” (Fruit Processing, July 1998, p. 262-265), by R. Nicolas in “Aseptic Filling of UHT Dairy Products in HDPE Bottles” (Food Tech. Europe, March/April 1995, p. 52-58) or in U.S. Pat. No. 6,536,188 to Taggart, which are incorporated herein by reference. In an embodiment, the method comprises heat treating the liquid creamer before filling the container. The method can also comprise adding a buffering agent in amount ranging from about 0.1% to about 1.0% by weight to the liquid creamer before homogenizing the liquid creamer. The buffering agent can be one or more of sodium mono-and di-phosphates, potassium mono-and di-phosphates, sodium mono- and bi-carbonates, potassium mono- and bi-carbonates or a combination thereof.

The creamer, when added to a beverage, produces a physically stable, homogeneous, whitened drink with a good mouthfeel, and body, smooth texture, and a pleasant taste with no off-flavors notes. The use of the creamer of the invention is not limited for only coffee applications. For example, the creamer can be also used for other beverages, such as tea or cocoa, or used with cereals or berries, as a creamer for soups, and in many cooking applications, etc.

A liquid creamer of the invention is preferably physically stable and overcome phase separation issues (e.g., creaming, plug formation, gelation, syneresis, sedimentation, etc.) during storage at refrigeration temperatures (e.g., about 4° C.), room temperatures (e.g., about 20° C.) and elevated temperatures (e.g., about 30 to 38° C.). The stable liquid creamers can have a shelf-life stability such as at least 6 months at 4° C. and/or at 20° C., 6 months at 30° C., and 1 month at 38° C. Stability may be evaluated by visual inspection of the product after storage.

The invention in an even further aspect relates to a beverage composition comprising a creamer composition as disclosed above. A beverage composition may e.g. be a coffee, tea, malt, cereal or cocoa beverage. A beverage composition may be liquid or in powder form. Accordingly, the invention relates to a beverage composition comprising a) a creamer composition of the invention, and b) a coffee, tea, malt, cereal, or cocoa product, e.g. an extract of coffee, tea, malt, or cocoa. If the beverage composition is in liquid form it may e.g. be packaged in cans, glass bottles, plastic bottles, or any other suitable packaging. The beverage composition may be aseptically packaged. The beverage composition may be produced by a method comprising a) providing a beverage composition base; and b) adding a creamer composition according to the invention to the beverage composition base. By a beverage composition base is understood a composition useful for producing a beverage by addition of a creamer of the invention. A beverage composition base may in itself be suitable for consumption as a beverage. A beverage composition base may e.g. be an extract of coffee, tea, malt, or cocoa.

A liquid creamer of the invention has good whitening capacity and is also stable (without feathering, de-oiling, other phase separation defects) when added to hot beverages (coffee, tea and like), even when coffee is made with hard water, and also provides good mouthfeel.

### EXAMPLES

By way of example and not limitation, the following examples are illustrative of various embodiments of the present disclosure.

### Example 1

### Preparation of Plant Protein Microparticles

Material

Commercial plant protein isolate powders were purchased from the following suppliers: soy protein isolate—Clarisoy™ 100 lot 10SF1000000000000PR30 (ADM, Decatur, Ill., USA), potato protein isolate—P306 lot 185076 (Solanic BV, Veendam, The Netherlands) and canola protein isolate—Isolexx lot BIOEXXI20120214 (BioExx, Saskatoon, Canada). The protein content in the powders (g/100 g) as determined by Kjeldhal analysis (Nx6.25) was: soy protein isolate 96.02, potato protein isolate 88.71 and canola protein isolate 87.4.

Hydrochloric acid and sodium hydroxide used for pH adjustments, dipotassium phosphate salt (K₂HPO₄) used as buffer and calcium chloride (CaCl₂) used to promote protein aggregation were from Merck (Darmstadt, Germany). High oleic sunflower oil used for preparation of model emulsions was from Oleificio Sabo (Manno, Switzerland).

For production of creamers at pilot scale, the following commercial ingredients were used: sodium caseinate, di-potassium phosphate, sugar, partially hydrogenated soybean/cottonseed oil, emulsifiers (mono- and di-glycerides), stabilizers (carrageenans).

Commercial fat-free and low-fat coffee creamers Nestlé Coffee-mate liquid fat-free and low-fat were bought in local supermarket. The protein concentration used for the preparation of the plant protein microparticles was set to 4% (w/w) for all protein sources. Thus, preliminary trials have shown that in this condition samples remained liquid upon heat treatment at pH 7.0. Lower concentration of plant protein could also have been used but for practical reasons it is suitable to work as close as possible to the limit of gelation so that subsequent concentration steps of the microparticles can be limited.

Methods

The heat treatment temperature was selected above the denaturation temperature of the protein isolates determined by differential scanning calorimetry and the time was chosen to reach a plateau in the conversion yield into microparticles. Therefore the following conditions were applied: soy protein isolate 85° C./15 min, potato protein isolate 85° C./15 min and canola protein isolate 90° C./20 min.

Protein dispersions were prepared at room temperature in closed glass bottles by dispersing known amount of powder into MilliQ™ water under gentle magnetic stirring for 2 hours in order to minimize air bubble formation. The pH range was screened between 4.0 and 7.0 in order to refine conditions for protein aggregation upon heat treatment to maximize conversion yield into microparticles. Protein dispersions were poured in 22 mL glass tubes sealed with a plastic cup and immersed in a water bath in order to reach the desired temperature of 85 or 90° C. It took about 2 minutes to reach the set temperatures after which the holding time of 15 or 20 minutes was performed. Then, tubes were cooled down in iced water in order to stop aggregation process. The preferred processing conditions to prepare plant protein microparticles are summarized in table 1.

TABLE 1
Preferred conditions for production of
4% (w/w) plant protein microparticles.

| protein | | calcium | | | conversion |
|---|---|---|---|---|---|
| source | pH | content | time/temperature | homogenization | yield |
| soy | 6.4 | 1 mM | 85° C./15 min | 1000 bar | 82% |
| potato | 5.4 | 0 mM | 85° C./15 min | 1000 bar | 93% |
| canola | 6.4 | 0 mM | 90° C./20 min | 1000 bar | 95% |

For soy proteins, it was found that the addition of 1 mM calcium improved the conversion yield and the microparticles density. The conversion yield is the fraction of the initial plant protein that is effectively converted into microparticles after treatment. As well, for all protein sources it was necessary to perform a subsequent homogenization of the microparticles in order to reduce their initial size and obtain a stable dispersion. To this purpose, dispersions of microparticles were circulated in an Emulsiflex-05 high pressure homogenizer (Avestin Europe GmbH, Mannheim, Germany), operating at a flow rate of 4 L·h-1 and a pressure of 1000 bars.

Determination of the Conversion Yield into Microparticles

The conversion yield was obtained by spectrophotometry at 280 nm upon determination of the protein content remaining soluble after centrifugation of the samples at 15,000 g for 20 minutes in order to remove microparticles. The ratio of the absorbance at 280 nm after removal of the microparticles and the initial absorbance of the untreated sample lead to the amount of soluble proteins. By difference to the initial protein content, the conversion yield could be calculated. For spectrophotometry, a Nicolet Evolution 100 spectrometer (Sysmex Digitana SA, Switzerland) was used and measurements were done in quartz cuvettes (Hellma, Germany).

Size Distribution of Plant Protein Microparticles

Particle size was determined by dynamic light scattering (DLS) using a Malvern Nanosizer ZS (Malvern Instruments, GMP, Renens, Switzerland). The apparatus is equipped with a He—Ne laser emitting at 633 nm and with a 4.0 mW power source. The instrument uses a backscattering configuration where detection is done at a scattering angle of 173° using an avalanche photodiode. The microparticle dispersions were diluted 100 times in MilliQ™ water and poured in squared plastic cuvettes (Sarstedt, Germany). Measurements were performed at 25° C. Depending on the sample turbidity the pathlength of the light was set automatically by the apparatus. The autocorrelation function G2(t) was calculated from the fluctuation of the scattered intensity with time. From the polynomial fit of the logarithm of the correlation function using the “cumulants” method, the z-average hydrodynamic diameter of the particles was calculated assuming that the diffusing particles were monodisperse spheres. In addition, the polydispersity index (PDI) was calculated from the ratio between the coefficients of the squared and linear terms of the polynomial “cumulants” fit.

Optical Density of Plant Protein Microparticles

The optical density (OD) of microparticle dispersions was determined at 25° C. by measuring the absorbance of the solutions at λ=500 nm using the same spectrophotometer than described previously. Before measurement, dispersions were diluted 100 times in MilliQ™ water to remain in the linear region of absorbance (below 1.8) and the measurement was repeated after 10 min. This experiment allowed determining colloidal stability of the microparticles considering that a variation of less than 10% of the optical density was a sign of particle stability against sedimentation.

Morphology of Plant Protein Microparticles

The microstructure of plant protein microparticles dispersions as well as model creamers was investigated by transmission electron microscopy (TEM) using the negative staining method. A drop of the protein dispersion was diluted to 1 g·L-1 in Millipore water and deposited onto a formware-carbon coated copper grid. The excess product was removed after 30 s using a filter paper. A droplet of 1% phosphotungstic acid at pH 7.0 was added for 15 s, removing any excess. After drying the grid at room temperature for 5 min, observations were made with an FEI Tecnai G2 Spirit BioTWIN transmission electron microscope operating at 120 kV (FEI company, The Netherlands). Images were recorded using a Quemesa camera (Olympus soft imaging solutions, Germany).

Results

The microparticles were characterized by a wide range of size and polydispersity depending on the protein source (Table 2). However, the stability of the optical density at 500 nm for 10 min was obvious since it did not decrease by less than 5% of its initial value.

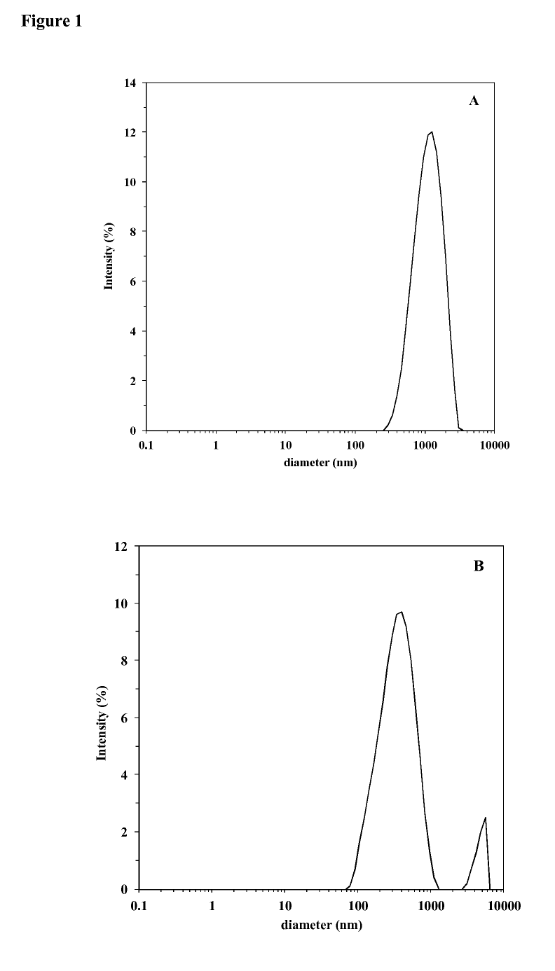

The particle size distributions for soy and potato proteins are shown in FIG. 1. It can be seen that potato microparticles were larger than soy ones, but that potato protein microparticles exhibited a narrow size distribution (FIG. 1A) compared to soy where a small intensity peak was visible at larger diameters (FIG. 1B). Canola protein microparticles were larger than the detection limit of the DLS apparatus but measurements using Mastersizer revealed an average D₃₂ diameter of 3010 nm. It was found that these microparticles exhibited high stability against sedimentation which might be a sign of a low density and maybe a porous structure. The overall size distributions of the microparticles felt within the predicted range of scattering properties so that these particles are exhibiting some whitening properties as presented in soluble coffee in table 2.

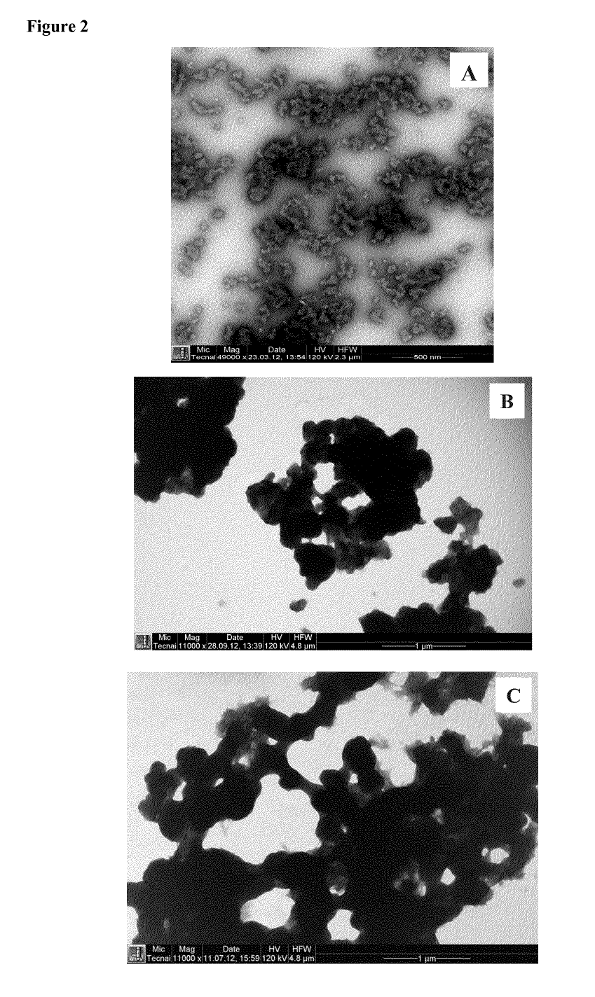

All 3 types of microparticles according to the invention were subjected to transmission electron microscopy in negative staining mode. The results are presented in FIG. 2. It can be seen that microparticles do exhibit an irregular shape, especially for soy where both spherical and elongated structures were visible (FIG. 2A). Microparticles produced with potato and canola proteins seemed more compact and exhibited a more aggregated status (FIGS. 2B and C) which is not only be due to the microscopy preparation technique but is also confirming the larger size determined by DLS. It was also surprisingly found that the canola microparticles exhibited a “sponge-like” structure with compact particles separated by large voids. This specific structure could explain the stability of these particles even if they have a large size. As well, light can be easily scattered through the pores of the particles, such as the particles would not be aggregated.

TABLE 2
Physicochemical properties of plant microparticles obtained by heat
treatment of protein isolates at 4% (w/w). Samples were diluted
1/100 in MilliQ ™ water for size determination and optical
density (OD) measurements. Lightness was measured in
soluble coffee by addition of 4% (w/w) plant protein microparticles.

| | | | | OD | lightness |
|---|---|---|---|---|---|
| | z-average | | | (500 nm) | in |
| protein | diameter | polydispersity | OD | after | soluble |
| source | (nm) | index | (500 nm) | 10 min | coffee |
| soy | 338 | 0.356 | 0.681 | 0.680 | 27 |
| potato | 995 | 0.167 | 1.612 | 1.612 | 34 |
| canola* | >3000 | / | 0.884 | 0.843 | 25 |

### Example 2

### Whitening Properties and Stability of Plant Protein Microparticles in Coffee

Method

Whitening properties of the plant protein microparticles produced in example 1 were evaluated in soluble coffee (2.6% (w/w)) or in roast and ground coffee (0.67% (w/w)). For soluble coffee, Nescafe Classic was reconstituted at 2.4% (w/w) in a mixture of ⅔ MilliQ™ water and ⅓ Vittel™ mineral water at 80° C. For roast and ground coffee, 40 g of Folgers classic roast coffee were prepared with 1500 mL of water (same mixture as before) using a automatic (paper filter porosity 4) coffee machine. The resulting coffee extraction yield was 0.67% (w/w). For determination of the whitening properties of plant protein microparticles or corresponding emulsions, coffee creamer and coffee were mixed at a 1/6 weight ratio. The colour properties L (whiteness), a and b of the mixtures were determined using a HunterLab ColorFlex apparatus (Hunter & Caprez AG, Zumikon, Switzerland).

Results

The stability and whitening properties of the plant protein microparticles has been investigated in 2.6% (w/w) soluble coffee in order to test the preferred protein concentration required to match the whitening properties of commercial low-fat and fat free creamers.

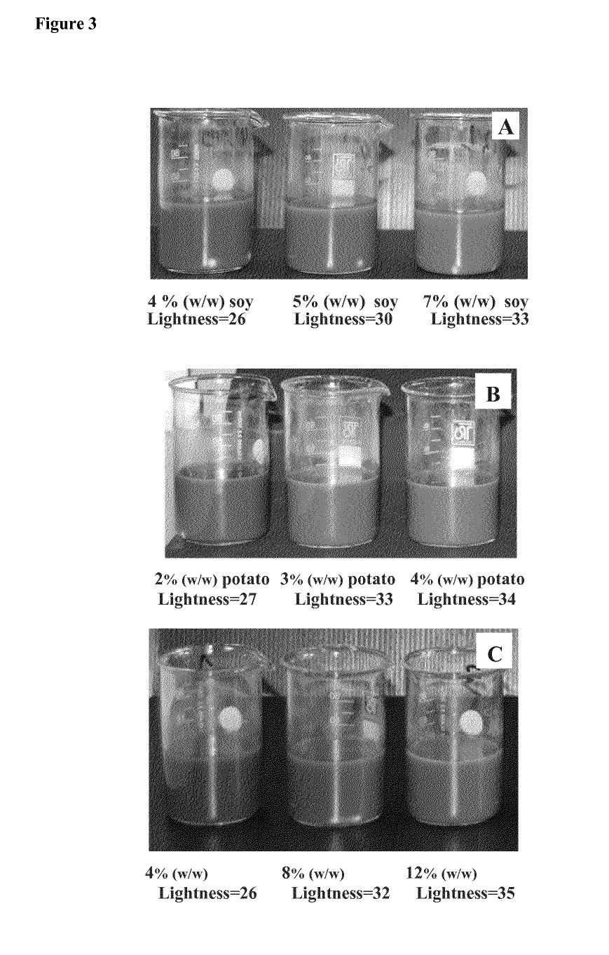

The results presented on FIG. 3 show the whitening properties of plant protein microparticles at various protein concentrations as well as the stability in soluble coffee.

It can be seen that the 3 types of plant protein microparticles were stable in pure coffee without the addition of any buffering salt. This shows already that even if the pH of soluble coffee is rather acidic (around 5.0), the buffering capacity of the microparticles due to the amphoteric character of proteins allows to obtain stable mixtures. When the whitening properties of the protein sources were compared, it could be concluded that potato microparticles had the highest whitening power, while soy and canola particles were very close. This specific feature could be related to the very narrow particle size of potato microparticles when compared to soy and canola.

The lightness of commercial fat free and low fat coffee creamers was matched by using were matching commercial creamers at 4% (w/w) potato, 8% (w/w) soy and 8% (w/w) canola protein microparticles. It is very likely that these differences are due to the slightly different microstructures and the size distributions of the protein whiteners, as already discussed previously.

### Example 3

### Preparation of Creamer Composition Containing Soy Protein Microparticles as Whitening Agent and Evaluation in Coffee

Methods

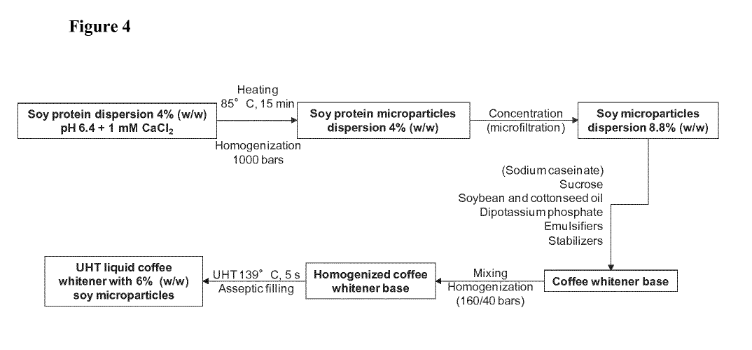

Fat-free creamers according to the invention were prepared using the process flow described in FIG. 4 and using the recipe presented in table 3.

An amount of 11.11 kg of soy protein isolate Clarisoy™ 100 was dispersed in 238.85 kg demineralised water and stirred for 45 minutes at 25° C. using a Ystral X50-10 rotor/stator mixer (Ystral GmbH, Dottingen Germany). Calcium chloride (0.04 kg) was added to lead to a calcium concentration of 1 mM and the pH was adjusted to 6.4 by addition of 1M NaOH (initial pH was 2.95). The dispersion was then heat treated at 85° C. for 15 minutes using an APV plate/plate heat exchanger equipped with a tubular holding tube of 15.8 L at a flow rate of about 240 L·h⁻¹. The obtained soy microparticles were cooled down to 10° C. before being homogenized at 1000/200 bars using a Panther NS3006L homogenizer (NIRO A/S—GEA, Parma, Italy). Then the soy microparticle dispersion was stored overnight at 4° C.

The next day, the dispersion was fed into a MMS microfiltration module (Pilot System Model SW40-C, MMS AG Membrane Systems, Urdorf, Switzerland) equipped with Kerasep 0.1 μm ceramic membranes (Novasep Process SAS, Miribel, France) in order to increase the concentration in microparticles. The temperature was set to 50° C. to increase permeation rate. The feeding rate was set to 1000 L·h⁻¹ and the recirculation loop to 22,000 L·h⁻¹. The permeate rate achieved was about 30 L·h⁻¹ with a AP of 1 bar. After 4 hours, the solid content in the retentate containing soy microparticles reached 10.25% (w/w). Demineralised water was added to reduce concentration to 8.8% (w/w). The corresponding dispersion was very stable and could be easily pumped. After storage at 4° C. overnight, the soy microparticle dispersion were split in two batches of 40 kg having a protein content of 8% (w/w). The temperature of the dispersions was increased to 50° C. and all the ingredients from the fat-free creamers (except sodium caseinate for one variant) were subsequently added so that the final concentration in soy microparticles in the mix was 6% (w/w). The mixes were then homogenized at 160/40 bars and UHT treated at 139° C. for 5 s using Multipurpose UHT Pilot Plant—SPP line (SPX Flow Technology GmbH, Unna, Germany). Products were then filled in 100 mL plastic bottles and stored at 4° C. until further analyses. The total solids of the two creamers according to the invention were about 40% (w/w).

TABLE 3
Composition of coffee creamers according to the
invention based on soy protein microparticles.

| | Creamer with sodium | Creamer without |
|---|---|---|
| Ingredients (% w/w) | caseinate | sodium caseinate |
| water | 60.15 | 60.15 |
| sugar | 30 | 30 |
| partially hydrogenated | 2 | 2 |
| soybean and cottonseed oil | | |
| soy protein microparticles | 6.0 | 7 |
| sodium caseinate | 1 | 0 |
| emulsifiers | 0.5 | 0.5 |
| stabilizers | 0.05 | 0.05 |
| flavour | 0.3 | 0.3 |

In addition to microstructure and whitening properties that were characterize using the method described above, the particle size distribution of coffee creamers according to the invention was determined by laser granulometry using a Mastersizer S granulometer (Malvern Instruments, GMP, Renens, Switzerland), that performs size measurements using a static multi-angle light scattering (MALS). The apparatus is equipped with a laser emitting at 633 nm. The optical set-up was composed by a reverse Fourier 300-RF lens combined with a 2.4 mm thin measuring cell. Emulsion samples were diluted in Millipore® water until the intensity of the laser beam decreased by ˜15% (obscuration). The average size of oil droplets and their size distribution was calculated by the equipment software according to Mie's theory. Standard polydisperse model was used, assuming a refractive index of 1.33 for the solvent and refractive and absorption index of 1.45 and 0.10 for the emulsion particles, respectively (presentation 3NHD).

Results

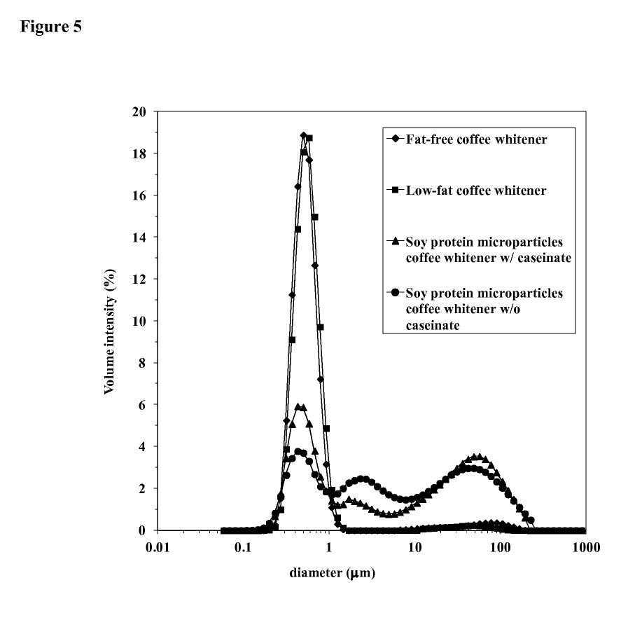

The particle size distributions of the two creamers according to the invention are compared with those of commercial creamers of FIG. 5. Commercial coffee creamers were mainly characterized by a narrow single peak that was centered on 600 nm. It is very likely that it corresponded to TiO₂ particles as well oil droplets stabilized by sodium caseinate. The creamers according to the invention did not exhibit this narrow size distribution, on the contrary, they exhibited 3 peaks ranging from 600 nm to 40 μm. Interestingly, the 600 nm peak was present for both creamers according to the invention, but was much lower in intensity compared to the commercial creamers. It is therefore very likely that the plant protein microparticles, due to their surface activity, were partially adsorbed at the surface of oil droplets, leading to their partial flocculation. Indeed, such hypothesis was confirmed by the broader size distribution obtained for the sample containing only soy microparticles as emulsifying agent.

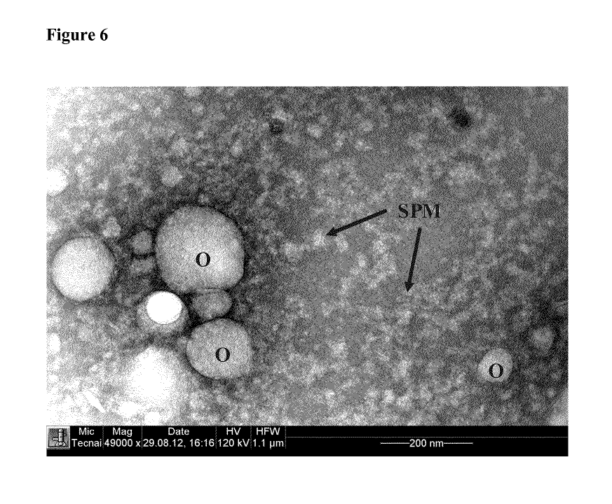

The microstructure of the creamers according to the invention stabilized by soy protein microparticles has been investigated by TEM microscopy (FIG. 6). From observation of FIG. 6, corresponding to model coffee creamer without sodium caseinate, it can be concluded that the soy protein microparticles could be identified as single aggregates, as was seen on FIG. 2A. These particles are responsible for the peak at 1 to 2 μm detected in the coffee creamer according to the invention. Interestingly, oil droplets with a size between 50 to 200 nm could be observed also, being characteristic for the smallest peak on the particle size distribution. Finally, strongly aggregated structures comprising both oil droplets and soy protein microparticles could be detected. These structures were probably responsible for the large particles of 40 mm detected by laser granulometry. It should be mentioned that very similar microstructure was obtained when sodium caseinate was used in combination with soy microparticles.

The use of soy protein microparticles was therefore inducing a partial flocculation of oil droplets and leading to a broad particle size distribution in the corresponding creamers.

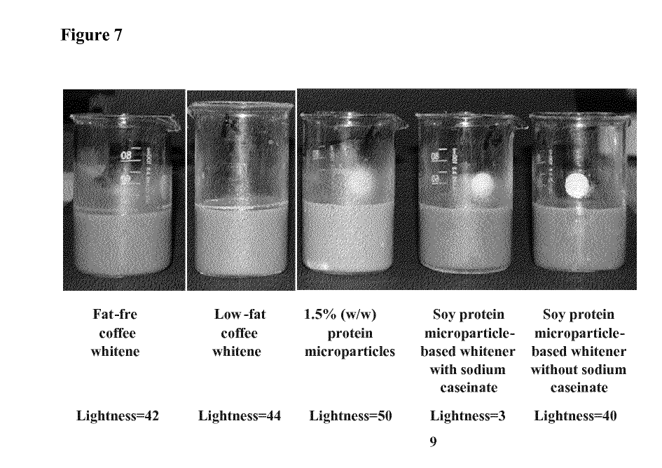

In the last stage, the creamers according to the invention were tested in roast and round coffee (1/6 weight mixing ratio) and compared to commercial CML creamers containing TiO₂. Pure soy protein microparticles at 8.8% (w/w) were stable in coffee and exhibited a higher lightness (L=50) than the commercial coffee creamers (L=42 to 43) (FIG. 7). When 6% (w/w) creamers according to the invention were produced with 6% (w/w) soy microparticles, both with and without sodium caseinate, they were stable to flocculation in roast and ground coffee. The whitening properties were slightly lower than those of low-fat coffee creamer, but very comparable those of fat free-creamers.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method for producing a whitening agent for a creamer composition comprising using plant protein microparticles to produce the whitening agent.

2. Method of claim 1, wherein the plant protein microparticles have an irregular shape.

3. Method of claim 1, wherein the plant protein microparticles have a size distribution from 100 to 4000 nm.

4. Method of claim 1, wherein the creamer composition has an optical density measured at 500 nm of at least 0.680 when measured after 10 minutes in 2.4% (w/w) soluble coffee.

5. Method of claim 1, wherein the creamer composition has a lightness of at least 25 when added at a level of 0.67% (w/w) when measured after 10 minutes in 2.4% (w/w) soluble coffee.

6. Method of claim 1 wherein the creamer composition comprises between 2% and about 12% plant protein microparticles by weight (w/w) of the creamer composition.

7. Method of claim 1 wherein the plant protein micro-particles are selected from the group consisting of soy protein, potato protein, canola protein or and combinations thereof.

8. Method of claim 1 wherein the creamer composition comprises between 0% and 10% oil or fat by weight (w/w).

9. Method of claim 1 wherein the creamer composition further comprises sucrose, emulsifiers, stabilizers, buffer salts, sweeteners, colours, flavours, and aroma.

10. Method of claim 9, wherein the emulsifiers are protein not in the form of microparticles.

11. Method of claim 1 wherein the creamer composition is devoid of titanium dioxide.

12. A beverage composition comprising a creamer composition comprising plant protein microparticles as a whitening agent.

13. The beverage composition of claim 12 wherein the composition is selected from the group consisting of a coffee, tea, malt, cereal, and cocoa beverage composition.

14. A method of producing a creamer composition, the method comprising
providing homogenised plant protein microparticles;
providing a creamer composition of sucrose, emulsifiers, stabilizers, buffer salts, sweeteners, other proteins, colours, aroma and flavours; and
adding the plant protein microparticles to the creamer composition.

15. A method of preparing a beverage composition, the method comprising:
providing a beverage composition base; and
adding a creamer composition comprising plant protein microparticles to the beverage composition base.
